(19) United States
(12) Patent Application Publication
(10) Pub. No.: US 2026/0109328 A1
(43) Pub. Date: Apr. 23, 2026

(54) BRAKE PEDAL DEVICE

(71) Applicant: DENSO CORPORATION, Kariya-city (JP)

(72) Inventors: Shinji KOMATSU, Nisshin-city (JP); Kengo ITO, Kariya-city (JP)

(21) Appl. No.: 19/423,935

(22) Filed: Dec. 17, 2025

Related U.S. Application Data
(63) Continuation of application No. PCT/JP2024/022427, filed on Jun. 20, 2024.

(30) Foreign Application Priority Data
Jul. 10, 2023 (JP) 2023-113003

(51) Int. Cl. B60T 7/04

(52) U.S. Cl. CPC B60T 7/042

(57) ABSTRACT

A brake pedal device includes a support portion, a shaft member, a pedal base, and a pedal operating portion. An axis of the shaft member is positioned on an opposite side of a center line in a thickness direction of the pedal base from a surface of the pedal base facing the driver. A heel of the shoe is placed against a position on the floor or the like that is a predetermined distance on the rear side of the vehicle from the axis, and the driver can press down on the pedal operating portion with both the ball and the pad of the big toe in contact with an insole of the shoe. A positional relationship between the shaft member and the pedal operating portion is defined so that an angle at which a driver's MTP joint bends in an extension side increases as a pedal stroke increases.

### CROSS REFERENCE TO RELATED APPLICATIONS

The present application is a continuation application of International Patent Application No. PCT/JP2024/022427 filed on Jun. 20, 2024, which designated the U.S. and claims the benefit of priority from Japanese Patent Application No. 2023-113003 filed on Jul. 10, 2023, the entire disclosure of the above application is incorporated herein by reference.

### TECHNICAL FIELD

The present disclosure relates to a brake pedal device mounted on a vehicle.

### BACKGROUND

Conventionally, pedal devices installed in vehicles, such as brake pedal device and accelerator pedal device, are known.

### SUMMARY

An object of the present disclosure is to provide a brake pedal device that can improve operability for a driver.

According to one aspect of the present disclosure, a brake pedal device mounted on a vehicle includes:

a support portion attached to the vehicle;

a shaft member provided on the support portion;

a pedal base provided rotatably around an axis of the shaft member within a predetermined angle range relative to the support portion; and

a pedal operating portion that is provided at the pedal base and is stepped on by a driver.

The axis is positioned on an opposite side of the pedal base from a surface of the pedal base that faces the driver with respect to a center line in a thickness direction of the pedal base.

When the driver wears a shoe and depresses the pedal operating portion, a positional relationship between the shaft member and the pedal operating portion is defined so that a heel of the shoe is brought into contact with a position on a floor of the vehicle or a member placed on the floor that is a predetermined distance on the rear side of the vehicle from the axis, and the driver steps on the pedal operating portion with both a ball and a pad of the big toe in contact with an insole of the shoe, and the angle at which a driver's MTP joint bends toward an extension side increases as a pedal stroke increases.

According to another aspect of the present disclosure, a brake pedal device mounted on a vehicle includes:

a support portion attached to the vehicle;

a shaft member provided on the support portion;

a pedal base provided rotatably around an axis of the shaft member within a predetermined angle range relative to the support portion; and

a pedal operating portion that is provided at the pedal base and is stepped on by a driver.

The axis is positioned on an opposite side of the pedal base from a surface of the pedal base that faces the driver with respect to a center line in a thickness direction of the pedal base.

When the pedal operating portion is depressed using a human body model, a positional relationship between the shaft member and the pedal operating portion is specified so that a heel of the human body model is brought into contact with a floor of the vehicle or a member placed on the floor at a position a predetermined distance on the rear side of the vehicle from the axis, and the pedal operating portion is depressed with both a ball and a pad of the big toe of the human body model in contact with the pedal operating portion, and an angle at which a MTP joint of the human body model bends toward an extension side increases as a pedal stroke increases.

According to further another aspect of the present disclosure, a brake pedal device mounted on a vehicle includes:

a support portion attached to the vehicle;

a shaft member provided on the support portion;

a pedal base provided rotatably around an axis of the shaft member within a predetermined angle range relative to the support portion; and

a pedal operating portion that is provided at the pedal base and is stepped on by a driver.

The axis is positioned on an opposite side of the pedal base from a surface of the pedal base that faces the driver with respect to a center line in a thickness direction of the pedal base.

The shaft member is positioned on an extension line of an operating portion average surface of the pedal operating portion, which is an average of an entire tread surface of the pedal operating portion facing the driver, throughout an entire range of the pedal stroke.

### BRIEF DESCRIPTION OF THE DRAWINGS

FIG. 1 is a side view showing a state in which a pedal base is in an initial position in a brake pedal device according to a first embodiment;

FIG. 2 is a side view showing a state in which a pedal base is in a full stroke position in the brake pedal device according to the first embodiment;

FIG. 3 is a cross-sectional view taken along a line III-III in FIGS. 1 and 2;

FIG. 4 is a side view showing a state in which the pedal base is in an initial position when a driver depresses the brake pedal device according to the first embodiment;

FIG. 5 is a side view showing a state in which the pedal base is in a full stroke position when a driver depresses the brake pedal device according to the first embodiment;

FIG. 6 is an explanatory diagram for explaining a behavior of an MTP joint when a driver depresses the brake pedal device according to the first embodiment;

FIG. 7 is an explanatory diagram for explaining a behavior of the MTP joint when the driver depresses the brake pedal device according to the first embodiment;

FIG. 8 is a graph showing a relationship between a pedal stroke and a behavior of a MTP joint angle in the brake pedal device according to the first embodiment;

FIG. 9 is a side view showing a brake pedal device of a first comparative example;

FIG. 10 is a diagram showing the results of an experiment in which foot pressure distribution was measured when a driver depressed the pedal operating portion of the brake pedal device of the first comparative example to a full stroke position;

FIG. 11 is a diagram showing the results of an experiment in which foot pressure distribution was measured when a driver depressed the pedal operating portion of the brake pedal device according to the first embodiment to a full stroke position;

FIG. 12 is an explanatory diagram for explaining a behavior of the MTP joint when the driver depresses the brake pedal device according to a second comparative example;

FIG. 13 is an explanatory diagram for explaining a behavior of the MTP joint when the driver depresses the brake pedal device according to the second comparative example;

FIG. 14 is a graph showing a relationship between a pedal stroke and a behavior of a MTP joint angle in the brake pedal device according to the second comparative example;

FIG. 15 is a side view of a brake pedal device according to a second embodiment;

FIG. 16 is a side view of a brake pedal device according to a third embodiment;

FIG. 17 is a side view of a brake pedal device according to a fourth embodiment;

FIG. 18 is a side view of a brake pedal device according to a fifth embodiment;

FIG. 19 is a side view of a brake pedal device according to a sixth embodiment;

FIG. 20 is a side view of a brake pedal device according to a seventh embodiment;

FIG. 21 is a side view of a brake pedal device according to an eighth embodiment; and

FIG. 22 is a side view of a brake pedal device according to a ninth embodiment.

### DETAILED DESCRIPTION

In an assumable example, pedal devices installed in vehicles, such as brake pedal device and accelerator pedal device, are known. The example discloses an organ structure type accelerator pedal device. The organ structure type refers to a pedal in which a pedal operating portion, which is a portion pressed by the driver, is positioned above an axis around which a pedal pivots, specifically on the upper side in the vehicle vertical direction (that is, an upper side of the vehicle). The accelerator pedal device is configured such that the pedal operating portion has a convex surface part and a flat surface part when viewed in a direction in which the axis of the pedal extends (hereinafter referred to as the "axis direction"). The convex part is a curved surface that is convex toward the driver (i.e., the rear side of the vehicle), and the flat part is a flat surface that is provided continuously with the convex part on the upper side of the vehicle. This accelerator pedal device is configured so that when the driver depresses the pedal, a contact point between the portion of the driver’s shoe corresponding to the ball of the big toe and the pedal operating part moves smoothly from a flat surface part to a convex surface part as the pedal stroke increases. The pedal stroke is also called a pedal operation amount.

However, in the accelerator pedal device, a distance between the sole of the driver’s shoe at the portion corresponding to the big toe and the flat surface part of the pedal operating portion gradually increases. as the pedal stroke increases. Therefore, with this accelerator pedal device, as the pedal stroke increases, the driver's big toe gradually comes off the insole of the shoe, and the driver ends up operating the pedal using only the ball of the big toe.

Generally, a brake pedal device mounted on a vehicle is set to generate a larger reaction force against the pedal force applied by the driver than the accelerator pedal device. Therefore, the pedal force required by the driver to operate the brake pedal device is greater than the pedal force required to operate the accelerator pedal device. Therefore, as the pedal stroke increases, the driver would be unable to apply a pedal force from the big toe to the pedal operating portion, resulting in a problem of deterioration in operability.

An object of the present disclosure is to provide a brake pedal device that can improve operability for a driver.

According to one aspect of the present disclosure, a brake pedal device mounted on a vehicle includes:

a support portion attached to the vehicle;

a shaft member provided on the support portion;

a pedal base provided rotatably around an axis of the shaft member within a predetermined angle range relative to the support portion; and

a pedal operating portion that is provided at the pedal base and is stepped on by a driver.

The axis is positioned on an opposite side of the pedal base from a surface of the pedal base that faces the driver with respect to a center line in a thickness direction of the pedal base.

When the driver wears a shoe and depresses the pedal operating portion, a positional relationship between the shaft member and the pedal operating portion is defined so that a heel of the shoe is brought into contact with a position on a floor of the vehicle or a member placed on the floor that is a predetermined distance on the rear side of the vehicle from the axis, and the driver steps on the pedal operating portion with both a ball and a pad of the big toe in contact with an insole of the shoe, and the angle at which a driver's MTP joint bends toward an extension side increases as a pedal stroke increases.

According to this configuration, the brake pedal device is configured so that the angle at which the driver's MTP joint is bent in the extension direction gradually increases as the pedal stroke increases. Therefore, as the pedal stroke increases, the contact area between the ball and the pad of the big toe and the insole of the shoe increases, and the foot pressure is distributed to the ball and the pad of the big toe, thereby mitigating excessive increases in foot pressure. Therefore, this brake pedal device provides a good feeling of depression by the ball and the pad of the big toe, improving operability for the driver.

The phrase "the angle at which the MTP joint bends in the extension direction gradually increases" refers, in terms of design, to the fact that the angle of extension at the MTP joint increases progressively. It does not refer to the driver intentionally bending the MTP joint against the movement of the pedal. The shoes are generally those used for driving a vehicle, such as sneakers, athletic shoes, and leather shoes. MTP stands for meta tarso phalangeal.

According to another aspect of the present disclosure, a brake pedal device mounted on a vehicle includes:

a support portion attached to the vehicle;

a shaft member provided on the support portion;

a pedal base provided rotatably around an axis of the shaft member within a predetermined angle range relative to the support portion; and

a pedal operating portion that is provided at the pedal base and is stepped on by a driver.

The axis is positioned on an opposite side of the pedal base from a surface of the pedal base that faces the driver with respect to a center line in a thickness direction of the pedal base.

When the pedal operating portion is depressed using a human body model, a positional relationship between the shaft member and the pedal operating portion is specified so that a heel of the human body model is brought into contact with a floor of the vehicle or a member placed on the floor at a position a predetermined distance on the rear side of the vehicle from the axis, and the pedal operating portion is depressed with both a ball and a pad of the big toe of the human body model in contact with the pedal operating portion, and an angle at which a MTP joint of the human body model bends toward an extension side increases as a pedal stroke increases.

This allows the behavior of the human body model to closely resemble that of the driver. Therefore, similar to the above-described one aspect of the present disclosure, the brake pedal device according to another aspect of the present disclosure is configured such that, when the driver operates the pedal, the angle at which the MTP joint of the human body model bends toward the extension side gradually increases as the pedal stroke increases. Therefore, the brake pedal device according to another aspect of the present disclosure can also improve operability by the driver.

The term "human body model" refers to a model generally used in vehicle design.

According to further another aspect of the present disclosure, a brake pedal device mounted on a vehicle includes:

a support portion attached to the vehicle;

a shaft member provided on the support portion;

a pedal base provided rotatably around an axis of the shaft member within a predetermined angle range relative to the support portion; and

a pedal operating portion that is provided at the pedal base and is stepped on by a driver.

The axis is positioned on an opposite side of the pedal base from a surface of the pedal base that faces the driver with respect to a center line in a thickness direction of the pedal base.

The shaft member is positioned on an extension line of an operating portion average surface of the pedal operating portion, which is an average of an entire tread surface of the pedal operating portion facing the driver, throughout an entire range of the pedal stroke.

According to this configuration, the brake pedal device according to further another aspect of the present disclosure is also configured in the same way as the one and another aspects of the present disclosure, so that the angle at which the driver's MTP joint bends toward the extension side gradually increases as the pedal stroke increases. Therefore, the brake pedal device according to further another aspect of the present disclosure can also improve operability by the driver.

Embodiments of the present disclosure will now be described with reference to the drawings. Parts that are identical or equivalent to each other in the following embodiments are assigned the same reference numerals and will not be described.

### First Embodiment

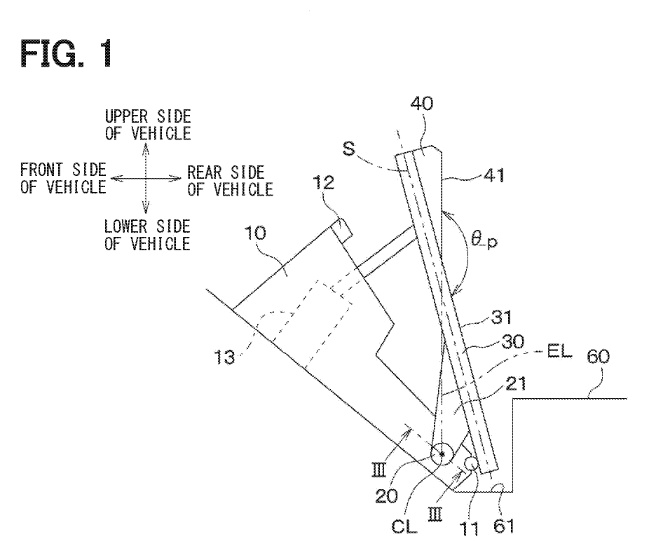

A first embodiment will be described. As shown in FIGS. 1-3, the brake pedal device according to the first embodiment is of an organ structure type mounted on a vehicle. The organ structure type refers to a brake pedal device in which a pedal operating portion 40, which is a portion of the brake pedal device that is depressed by a driver, is disposed on the upper side of the vehicle relative to an axis CL of rotation when mounted on the vehicle. In the brake pedal device of the organ structure type, the pedal operating portion 40 rotates toward a front side and a lower side of the vehicle in response to an increase in a pedal force applied by the driver to the pedal operating portion 40. In each drawing, arrows indicate the upper, lower, front, and rear sides of the vehicle when the brake pedal device is mounted on the vehicle.

The brake pedal device according to the first embodiment is used in a brake-by-wire system. The brake-by-wire system is a system in which an electronic control device mounted on the vehicle controls the driving of a brake circuit to brake the vehicle based on an electrical signal output from a sensor unit 50 provided in the brake pedal device.

As shown in FIGS. 1-3, the brake pedal device includes a support portion 10, a shaft member 20, a pedal base 30, the pedal operating portion 40, the sensor unit 50, and the like.

The support portion 10 is attached to a floor 60 or a dash panel inside a passenger compartment of the vehicle. The support portion 10 is sometimes called a housing. The dash panel is a partition wall that separates the interior of the vehicle from the exterior such as the engine room of the vehicle, and is sometimes called a bulkhead. In the first embodiment, the support portion 10 is attached to a recessed portion 61 provided in a floor 60 of the vehicle. The recessed portion 61 is a portion recessed on the lower side of the vehicle from the floor 60 or a member placed on the floor 60 (hereinafter referred to as "floor 60, etc."). Therefore, the brake pedal device is mounted so that the axis CL of the shaft member 20 is located on the lower side of the vehicle relative to the floor 60 or the like in the vehicle vertical direction (i.e., lower direction of the vehicle). The members placed on the floor 60 are, for example, floor mats, floor carpets, etc.

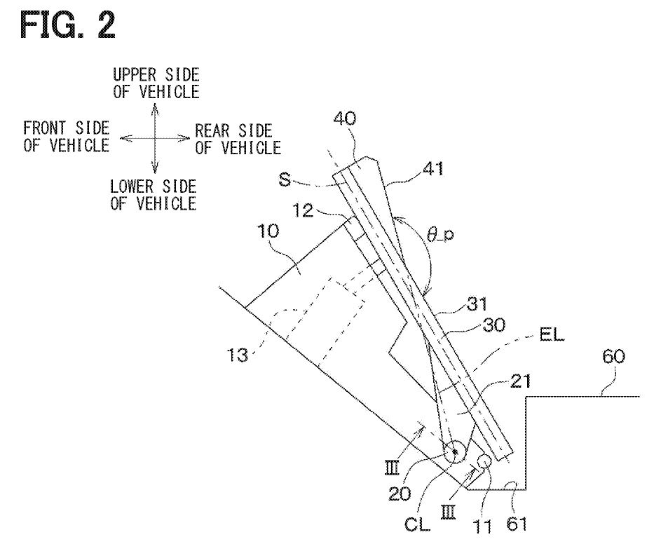

An initial stopper 11 that determines an initial position of the pedal base 30 and a full stroke stopper 12 that determines a full stroke position of the pedal base 30 are provided on an outer wall of the support portion 10. The initial position refers to a position where the driver is not applying a pedal force to the pedal operating portion 40 and the pedal base 30 is in an initial state due to the biasing force generated by a reaction force generating mechanism 13, as shown in FIG. 1. The full stroke position refers to a position where the pedal base 30 is depressed to the maximum extent against the biasing force generated by the reaction force generating mechanism 13 when the driver applies a pedal force to the pedal operating portion 40, as shown in FIG. 2.

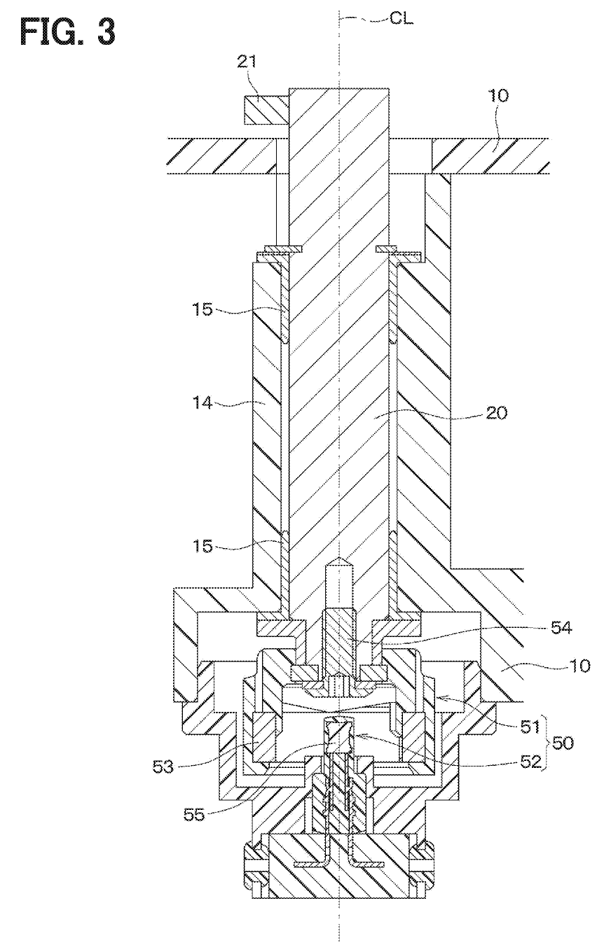

As shown in FIG. 3, a bearing portion 14 for rotatably supporting the shaft member 20 is provided inside the support portion 10. The shaft member 20 is rotatably supported by the bearing portion 14 via a bearing 15. Therefore, the shaft member 20 is rotatable about its own axis CL.

Furthermore, a space is formed inside the support portion 10 in which the sensor unit 50, the reaction force generating mechanism 13, etc. are provided. By providing the reaction force generating mechanism 13, the brake pedal device can obtain the same reaction force as when connected to the master cylinder, even if a mechanical connection between the master cylinder that constitutes the conventional brake circuit and the pedal base 30 is eliminated. A situation in which the brake device is connected to the master cylinder means that hydraulic reaction force is obtainable from the master cylinder.

As shown in FIGS. 1 and 2, the shaft member 20 and the pedal base 30 are fixed to each other via a connecting portion 21. That is, one end of the connecting portion 21 is fixed to the shaft member 20 and the other end is fixed to the pedal base 30. Therefore, the pedal base 30 can rotate around the axis CL relative to the support portion 10 within a predetermined angle range. The pedal base 30 is formed in a plate shape. Although not shown in the drawings, the pedal base 30 is not limited to a plate shape, but may also be a rod shape or a curved shape.

In FIG. 1, a center line S of the pedal base 30 in the thickness direction is indicated by a broken line. The shaft member 20 is located on the opposite side of the center line S of the pedal base 30 in the thickness direction to the surface 31 of the pedal base 30 that faces the driver side (i.e., the rear side of the vehicle). More specifically, in the first embodiment, the shaft member 20 is provided at a position spaced a predetermined distance from the pedal base 30. By arranging the axis CL of the shaft member 20 and the pedal base 30 at positions separated from each other, it is possible to provide the sensor unit 50 in the space around the axis CL.

As shown in FIG. 3, the sensor unit 50 is provided on the axis CL of the shaft member 20, and detects the rotation angle of the shaft member 20, the pedal base 30, and the pedal operating portion 40 relative to the support portion 10. The rotation angle corresponds to the pedal stroke. The sensor unit 50 has a rotating portion 51 provided on the shaft member 20 and a signal output portion 52 provided on the support portion 10 for outputting a signal corresponding to the phase of the rotating portion 51. In the present embodiment, a non-contact sensor capable of detecting the pedal stroke without contact between the rotating portion 51 and the signal output portion 52 is used as the sensor unit 50.

The rotating portion 51 is a magnetic circuit formed by, for example, a magnet 53 and a yoke, and is fixed to the shaft member 20 by a bolt 54 and rotates together with the shaft member 20. On the other hand, the signal output portion 52 is composed of one or more Hall ICs 55 and the like. When the rotating portion 51 rotates around the axis CL together with the shaft member 20, the density of the magnetic flux passing through the magnetic sensing surface of the Hall element of the Hall IC 55 changes. Therefore, the signal output portion 52 outputs an electrical signal corresponding to the pedal stroke.

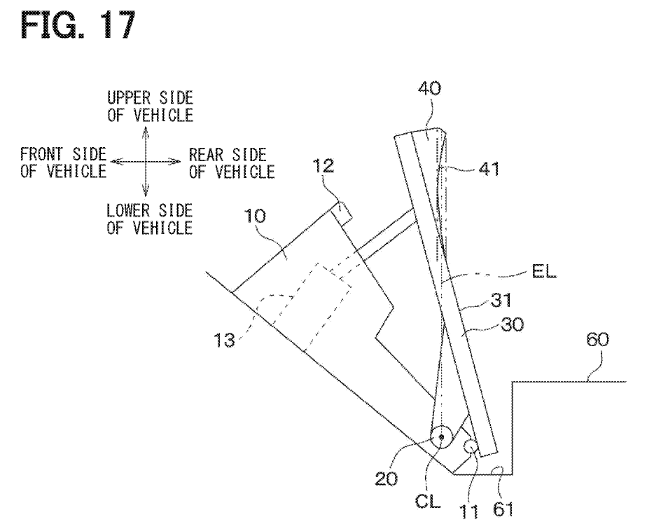

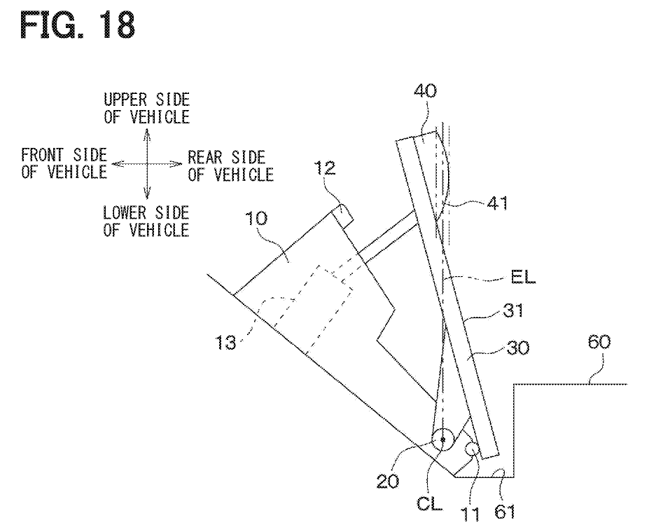

As shown in FIGS. 1 and 2, the pedal operating portion 40 is provided at a position on the pedal base 30 away from the shaft member 20 on the upper side of the vehicle relative to the axis CL. The pedal operating portion 40 is a part that is stepped on by the driver, in other words, a part that comes into contact with the sole of the driver's shoe. In the first embodiment, the tread surface 41 of the pedal operating portion 40 facing the driver is formed in a flat shape. In this disclosure, the term "flat" includes not only a completely flat surface but also a surface with irregularities such as an anti-slip surface. As will be described later in the fourth and fifth embodiments with reference to FIGS. 17 and 18, the pedal operating portion 40 is not limited to a flat shape, but may also have a curved shape such as a concave or convex shape.

Here, the average surface of the entire tread surface 41 of the pedal operating portion 40 is referred to as the operating portion average surface, and the average surface of the entire surface 31 of the pedal base 30 facing the driver is referred to as the base average surface. At this time, the angle θ_p formed between the operating portion average surface and the base average surface is smaller than 180° on the driver's side. That is, the operating portion average surface is a surface that is inclined on the upper side of the vehicle toward the driver (i.e., the rear side of the vehicle) with respect to the base average surface.

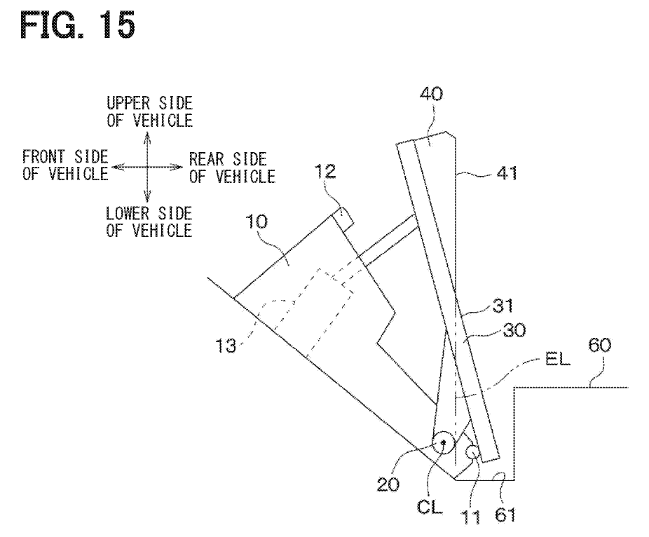

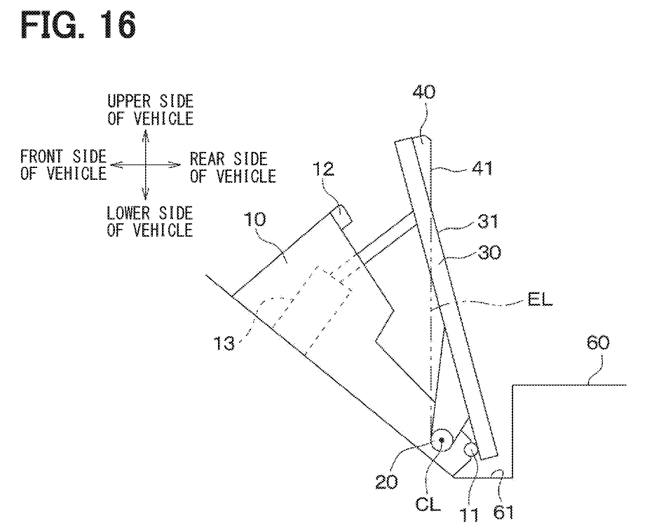

In FIGS. 1 and 2, an extension line EL of the operating portion average surface is indicated by a two-dot chain line. As shown in FIGS. 1 and 2, in the brake pedal device of the first embodiment, the shaft member 20 is positioned on an extension line EL of the operating portion average surface from the initial position to the full stroke position. In other words, the shape of the tread surface 41 of the pedal operating portion 40 is specified so that the shaft member 20 is positioned on the extension line EL of the operating portion average surface throughout the entire range of the pedal stroke, and preferably so that the axis CL of the shaft member 20 is positioned. The tread surface 41 of the pedal operating portion 40 may be shaped so that a portion of the shaft member 20 is positioned on the extension line EL of the operating portion average surface, as will be described later in the second and third embodiments with reference to FIGS. 15 and 16.

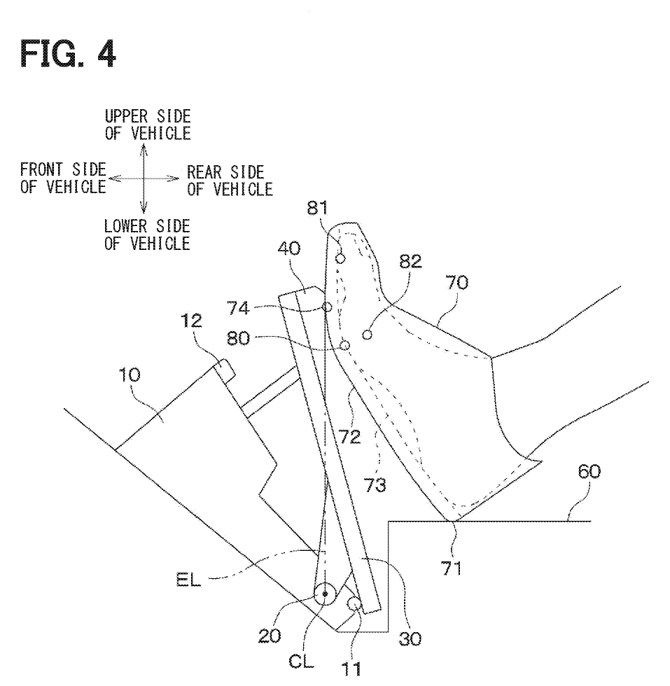

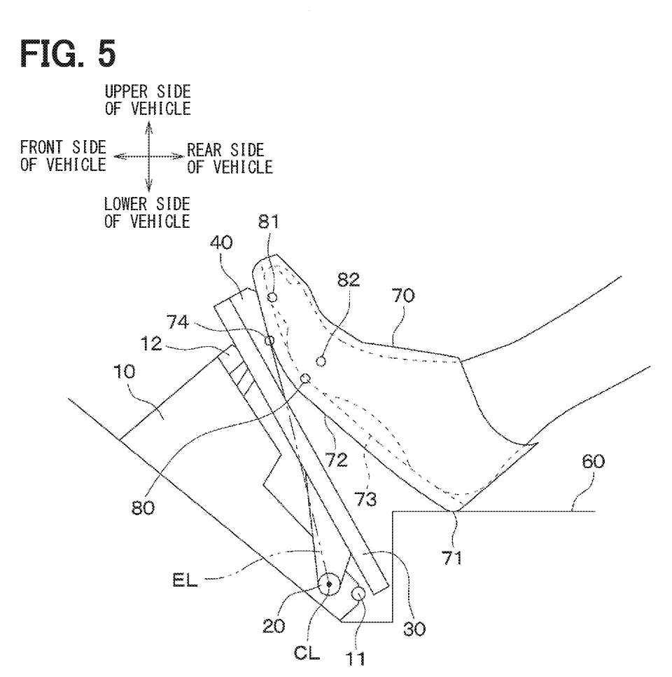

FIGS. 4 and 5 show a state in which a driver, wearing a shoe 70, depresses the brake pedal device according to the first embodiment described above. The shoes 70 in the present disclosure are shoes 70 generally used for driving a vehicle, such as sneakers, athletic shoes, leather shoes, etc.

As shown in FIGS. 4 and 5, when the driver depresses the brake pedal device, the driver places the heel 71 of the shoe 70 in contact with a position on the floor 60 or the like that is a predetermined distance on the rear side of the vehicle from the axis CL, and places a part of the sole 72 in contact with the pedal operating portion 40. The brake pedal device of the first embodiment allows the driver to operate the pedal operating portion 40 by depressing it while keeping both the ball 80 of the big toe and the pad 81 of the big toe in contact with the insole 73 of the shoe 70 throughout the entire range of the pedal stroke. As the pedal stroke increases, a center position 74 of the contact point between the sole 72 and the pedal operating portion 40 moves from an upper position to a lower position within the pedal operating portion 40. Furthermore, the brake pedal device of the first embodiment is configured so that the angle at which the driver's MTP joint 82 is bent toward the extension side gradually increases as the pedal stroke increases. An increase in the angle at which the MTP joint 82 bends toward the extension side means that the angle at which a proximal phalanx of the big toe bends toward the extension side (i.e., dorsal side) relative to a first metatarsal bone increases. As a result, as the pedal stroke increases, the contact area between the ball 80 and the pad 81 of the big toe and the insole 73 of the shoe increases, and the foot pressure is distributed to the ball 80 and the pad 81 of the big toe, thereby mitigating excessive increases in foot pressure. Therefore, a good pedal feel can be obtained, and operability by the driver can be improved. Furthermore, the angle at which the driver's MTP joint 82 bends toward the extension side gradually increases as the pedal stroke increases, which is similar to a terminal stance that most activates the triceps surae during walking, making it easier for the driver to transmit pedal force to the pedal operating portion 40. This leads to an improvement in the pedal feel. In addition, the fact that there are many proprioceptive mechanoreceptors distributed in the ball 80 and pad 81 of the big toe also contributes to improving the feel of stepping.

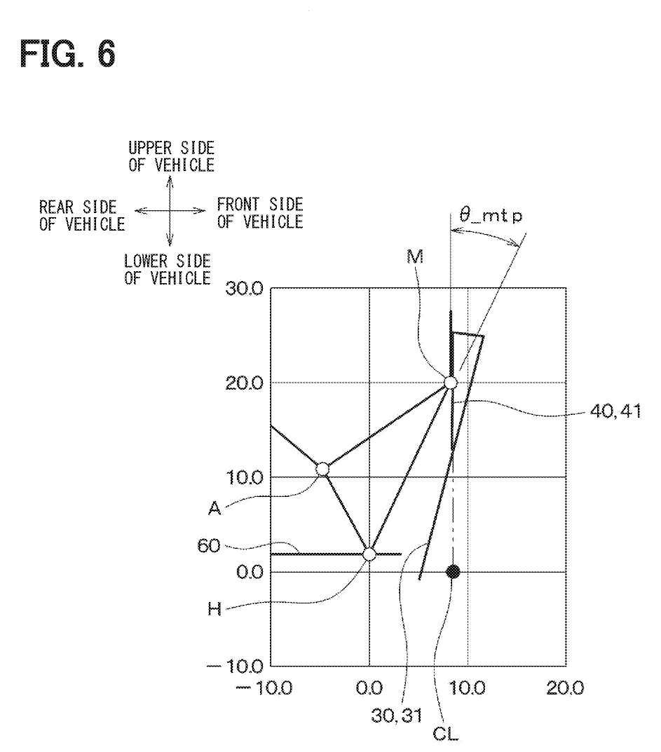

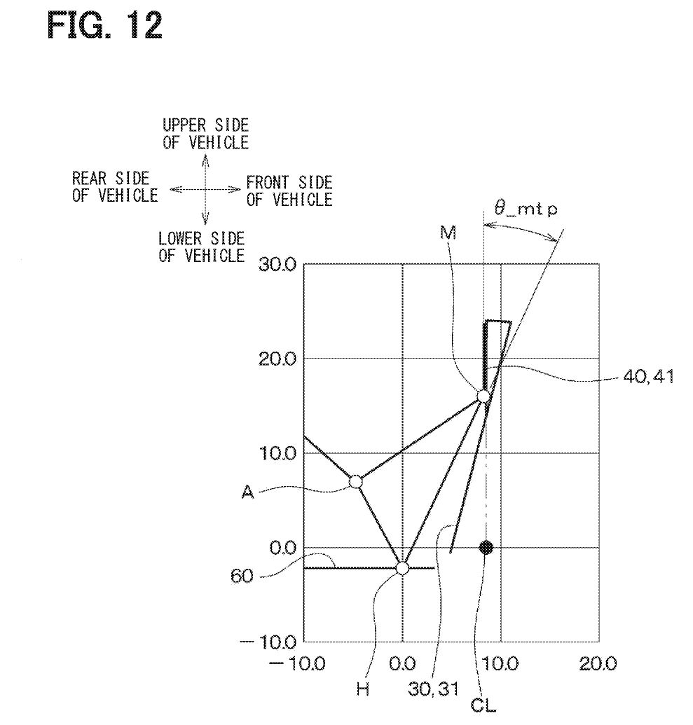

Next, the relationship between the behavior of the driver's MTP joint 82 and the pedal stroke, which has been studied by the present discloser, will be described with reference to FIGS. 6-8. In the following description with reference to FIGS. 6-8, the driver can be read as a human body model. This also applies to the description of a second comparative example described later with reference to FIGS. 12-14. In this disclosure, the term "human body model" refers to a model generally used in vehicle design.

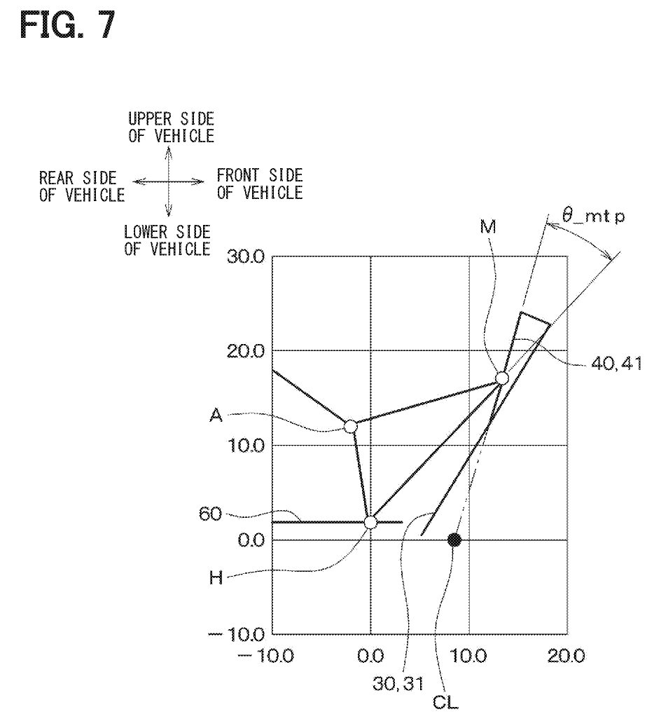

FIGS. 6 and 7 are schematic diagrams showing the driver's foot and the brake pedal device. In FIGS. 6 and 7, the heel of the driver is indicated by a circle H, the ankle joint is indicated by a circle A, the MTP joint 82 and the ball 80 of the big toe are collectively indicated by a circle M, and the angle of the MTP joint 82 is indicated by θ_mtp. The ankle joint is also called the talocrural joint. The components of the brake pedal device, the floor 60, etc. are designated by the same reference numerals as those described above.

As described above, the brake pedal device of the first embodiment is attached so that the axis CL of the shaft member 20 is positioned on the lower side of the vehicle relative to the floor 60 (or the like) of the vehicle. In the example shown in FIGS. 6 and 7, the axis CL of the shaft member 20 is located 20 mm on the lower side of the vehicle relative to the floor 60 and the like of the vehicle.

FIG. 6 shows the pedal stroke at its initial position, and FIG. 7 shows the pedal stroke at its full stroke position. As shown in FIGS. 6 and 7, the driver places the heel H of his/her foot on the floor 60 or the like at a position a predetermined distance on the rear side of the vehicle from the axis CL, and places both the ball 80 and the pad 81 of the big toe on the pedal operating portion 40. As the state changes from FIG. 6 to FIG. 7, that is, as the pedal stroke increases, the ball 80 of the big toe (i.e., circle M) moves from an upper position to a lower position within the pedal operating portion 40.

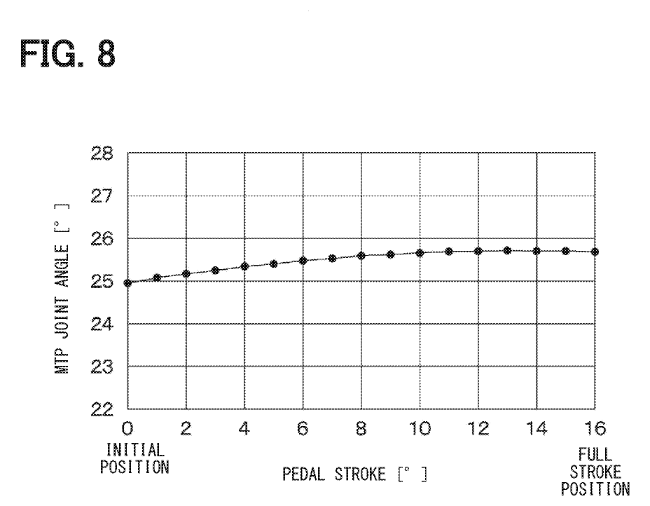

FIG. 8 is a graph showing the behavior of the angle θ_mtp of the MTP joint 82 as the pedal stroke transitions from FIG. 6 to FIG. 7. The horizontal axis of FIG. 8 represents the pedal stroke, and the vertical axis represents the angle θ_mtp of the MTP joint 82. The pedal stroke is 0° at the initial position and 16° at the full stroke position.

As shown in FIG. 8, when the pedal stroke is at the initial position, the angle of the MTP joint 82 is 25°, and the angle θ_mtp of the MTP joint 82 gradually increases as the pedal stroke increases. When the pedal stroke is at the full stroke position, the angle θ_mtp of the MTP joint 82 is near 26°. In this way, the brake pedal device of the first embodiment is configured so that the angle at which the driver's MTP joint 82 is bent toward the extension side gradually increases as the pedal stroke increases.

Here, two comparative examples will be described for comparison with the brake pedal device of the first embodiment. The two comparative examples were devised by the same discloser as those in the present disclosure, and are not prior art.

### First Comparative Example

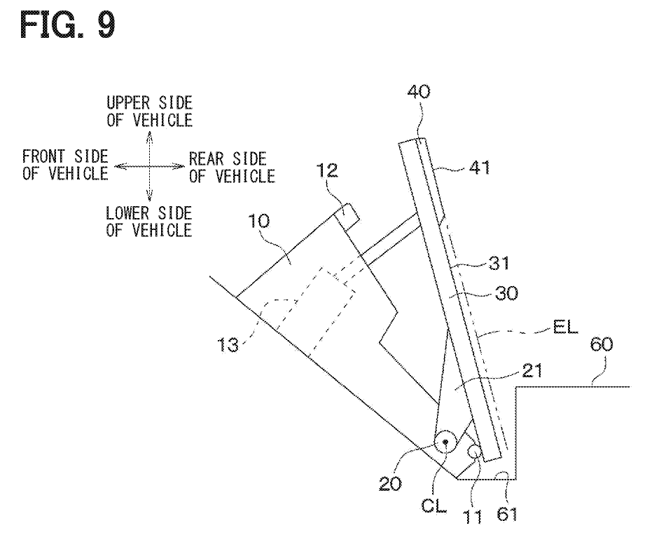

As shown in FIG. 9, the brake pedal device of the first comparative example differs from that described in the first embodiment only in the shape of the pedal operating portion 40, and the other configurations are the same as those described in the first embodiment.

In the brake pedal device of the first comparative example, the tread surface 41 of the pedal operating portion 40 facing the driver and the surface 31 of the pedal base 30 facing the driver are formed parallel to each other. Therefore, in the brake pedal device of the first comparative example, the shaft member 20 does not exist on the extension line EL of the operating portion average surface.

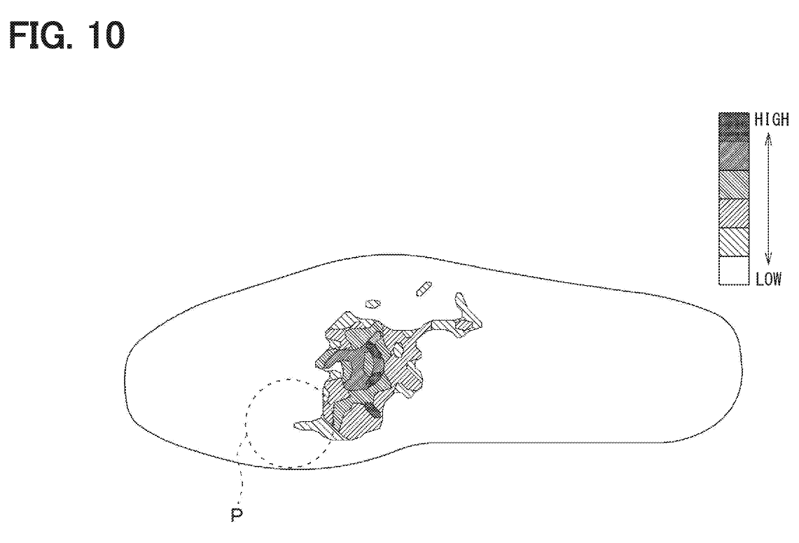

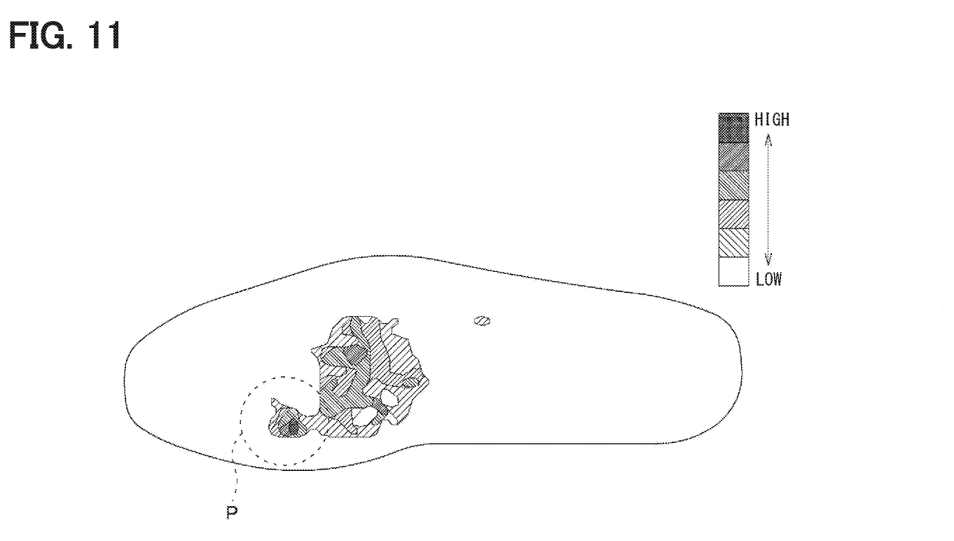

The disclosers conducted an experiment to measure the foot pressure distribution acting on the insole 73 of the shoe 70 when a driver wearing the shoe 70 depressed the brake pedal device to the full stroke position for each of the brake pedal device of the first comparative example and the brake pedal device of the first embodiment. The experimental results are shown in FIGS. 10 and 11.

In FIGS. 10 and 11, the area corresponding to the pad 81 of the big toe is indicated by a broken line P. As shown in the area indicated by the broken line P in FIG. 10, the brake pedal device of the first comparative example resulted in almost no foot pressure distribution being observed at the pad 81 of the big toe. In contrast, as shown by the broken line P in FIG. 11, the brake pedal device of the first embodiment resulted in a sufficient foot pressure distribution at the pad 81 of the big toe.

The results of this experiment showed that, compared to the brake pedal device of the comparative example, when a driver wearing shoes 70 presses the brake pedal device to the full stroke position, the foot pressure of the brake pedal device of the first embodiment is distributed to the ball 80 and the pad 81 of the big toe, thereby mitigating excessive increases in foot pressure. This result is due to the configuration of the brake pedal device of the first embodiment, in which the angle θ_mtp of the MTP joint 82 bends gradually toward the extension side as the pedal stroke increases.

### Second Comparative Example

Next, a second comparative example will be described with reference to FIGS. 12-14. The configuration of the brake pedal device used in the description of the second comparative example is the same as that described in the first embodiment. In the second comparative example, only the mounting position of the brake pedal device relative to the floor 60 of the vehicle is different from that described in the first embodiment.

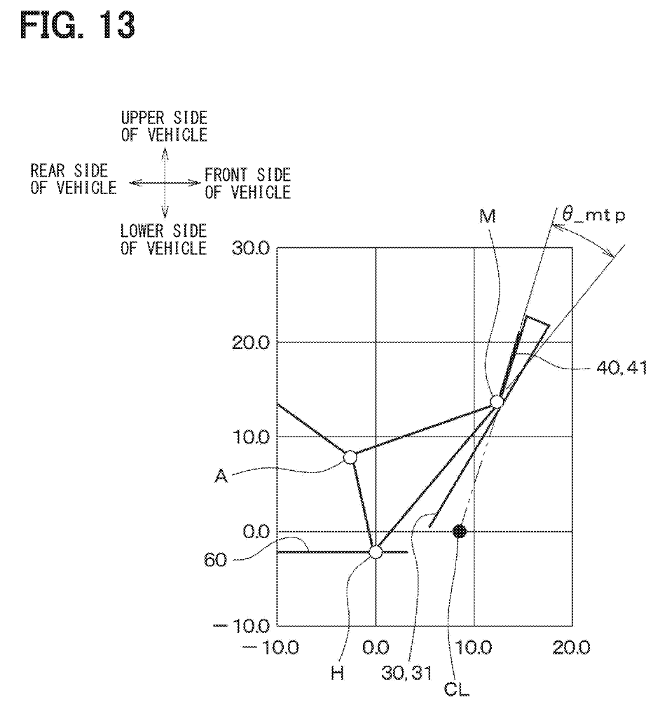

FIGS. 12 and 13 are schematic diagrams showing the driver's foot and the brake pedal device. As shown in FIGS. 12 and 13, in the second comparative example, the brake pedal device is mounted so that the axis CL of the shaft member 20 is located above the floor 60 or the like in the vehicle vertical direction (i.e., on the upper side of the vehicle). In this example, the axis CL of the shaft member 20 is located 20 mm above the floor 60 on the upper side of the vehicle.

FIG. 12 shows the pedal stroke at its initial position, and FIG. 13 shows the pedal stroke at its full stroke position. As shown in FIGS. 12 and 13, the driver places the heel H of his/her foot on the floor 60 or the like at a position a predetermined distance on the rear side of the vehicle from the axis CL, and places both the ball 80 and the pad 81 of the big toe on the pedal operating portion 40. As the state changes from FIG. 12 to FIG. 13, that is, as the pedal stroke increases, the ball 80 of the big toe (i.e., circle M) moves from an upper position to a lower position within the pedal operating portion 40.

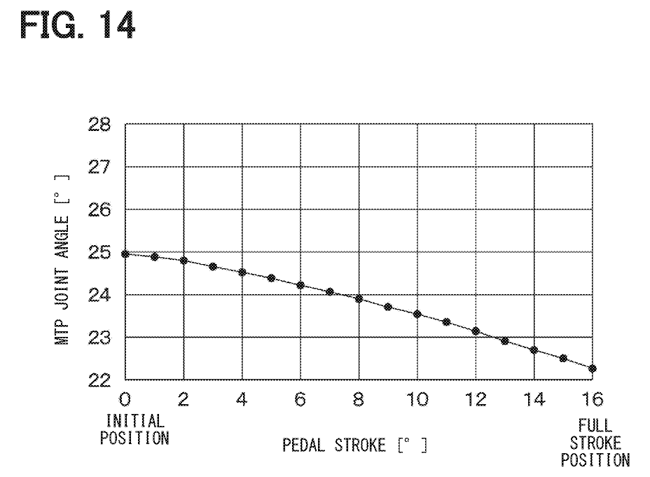

FIG. 14 is a graph showing the behavior of the MTP joint 82 as the pedal stroke transitions from FIG. 12 to FIG. 13. The horizontal axis of FIG. 14 represents the pedal stroke, and the vertical axis represents the angle θ_mtp of the MTP joint 82. The pedal stroke is 0° at the initial position and 16° at the full stroke position.

As shown in FIG. 14, when the pedal stroke is at the initial position, the angle θ_mtp of the MTP joint 82 is 25°, and as the pedal stroke increases, the angle θ_mtp of the MTP joint 82 gradually decreases. When the pedal stroke is at the full stroke position, the angle θ_mtp of the MTP joint 82 is near 22°. In this way, in the second comparative example, the angle at which the driver's MTP joint 82 bends toward the extension side decreases as the pedal stroke increases.

Compared to the first and second comparative examples, the brake pedal device of the first embodiment has the following advantages.

(1) In the brake pedal device of the first embodiment, the driver can operate the pedal operating portion 40 by placing the heel 71 of the shoe 70 on a position on the floor 60 or the like that is a predetermined distance on the rear side of the vehicle from the axis CL, and with both the ball 80 and the pad 81 of the big toe in contact with the insole 73 of the shoe 70. In the brake pedal device, the positional relationship between the shaft member 20 and the pedal operating portion 40 is specified so that when the driver depresses the pedal operating portion 40 in this manner, the angle at which the driver's MTP joint 82 bends toward the extension side increases as the pedal stroke increases.

According to this configuration, the brake pedal device is configured so that the angle at which the driver's MTP joint 82 is bent in the extension direction gradually increases as the pedal stroke increases. Therefore, as the pedal stroke increases, the contact area between the ball 80 and the pad 81 of the big toe and the insole 73 of the shoe 70 increases, and the foot pressure is distributed to the ball 80 and the pad 81 of the big toe, thereby mitigating excessive increases in foot pressure. Therefore, this brake pedal device provides a good feeling of depression by the ball 80 and the pad 81 of the big toe, improving operability for the driver.

(2) In the first embodiment, the axis CL of the shaft member 20 is located on the opposite side of the center line S in the thickness direction of the pedal base 30 from the surface 31 of the pedal base 30 facing the driver. The brake pedal device includes a sensor unit 50 on the axis CL of the shaft member 20.

According to this configuration, by positioning the axis CL of the shaft member 20 on the opposite side of the surface 31 of the pedal base 30 facing the driver with respect to the center line S in the thickness direction of the pedal base 30, a space is formed around the axis CL, making it possible to install the sensor unit 50 on the axis CL. The sensor unit 50 can directly detect the rotation angles of the shaft member 20, the pedal base 30, and the pedal operating portion 40, and can output a highly accurate electrical signal corresponding to the amount of pedal operation (i.e., pedal stroke) by the driver. Therefore, this brake pedal device can improve the accuracy of detecting the pedal stroke in a brake-by-wire system, thereby achieving more accurate vehicle driving control.

(3) The brake pedal device of the first embodiment is an organ structure type in which the pedal operating portion 40 is disposed on the upper side of the vehicle with respect to the axis CL. The angle θ_p formed between the operating portion average surface and the base average surface is smaller than 180° on the driver's side (i.e., the rear side of the vehicle).

This makes it possible to realize a configuration in the brake pedal device in which the angle at which the driver's MTP joint 82 bends toward the extension side gradually increases as the pedal stroke increases.

(4) In the first embodiment, the shaft member 20 is positioned on the extension line EL of the operating portion average surface over the entire range of the pedal stroke.

This makes it possible to realize a configuration in the brake pedal device in which the angle at which the driver's MTP joint 82 bends toward the extension side gradually increases as the pedal stroke increases.

In addition, "the shaft member 20 is positioned on the extension line EL of the operating portion average surface" means that the axis CL of the shaft member 20 is positioned on the extension line EL of the operating portion average surface, as well as that a part of the shaft member 20 is positioned on the extension line EL of the operating portion average surface.

(5) In the first embodiment, the axis CL of the shaft member 20 is positioned on the lower side of the vehicle relative to the floor 60 and the like of the vehicle.

This makes it possible to enhance the tendency of the driver's MTP joint 82 to gradually increase the angle of bending toward the extension side as the pedal stroke increases in the brake pedal device.

(6) As described with reference to FIGS. 6-8, the brake pedal device of the first embodiment can also be defined by the foot movements of a human body model. That is, in this brake pedal device, the heel H of the human body model is brought into contact with a position on the floor 60 or the like that is a predetermined distance on the rear side of the vehicle from the axis CL, and the pedal operating portion 40 can be depressed and operated with both the ball 80 and the pad 81 of the big toe of the human body model in contact with the pedal operating portion 40. In the brake pedal device, the positional relationship between the shaft member 20 and the pedal operating portion 40 is defined so that when the pedal operating portion 40 is depressed by the human body model, the angle at which the MTP joint 82 of the human body model ends toward the extension side gradually increases as the pedal stroke increases.

This allows the behavior of the human body model to closely resemble that of the driver. Therefore, the brake pedal device defined by the movement of the human body model as described above also provides a good feeling of pressure when the driver presses the pedal with the ball 80 and the pad 81 of the big toe, improving operability for the driver.

### Second to Sixth Embodiments

The second to sixth embodiments are different from the first embodiment in the configuration of the pedal operating portion 40, but are otherwise similar to the first embodiment, so only the parts that are different from the first embodiment will be described.

### Second Embodiment

As shown in FIG. 15, in the brake pedal device of the second embodiment, a portion of the shaft member 20 that is on the vehicle rear side of the axis CL is located on an extension line EL of the operating portion average surface. In other words, the shape of the tread surface 41 of the pedal operating portion 40 is defined so that a part of the shaft member 20 is positioned on an extension line EL of the operating portion average surface over the entire range of the pedal stroke. The diameter of the shaft member 20 is, for example, about 5 to 10 mm. This configuration also makes it possible to realize a configuration in which the angle at which the driver's MTP joint 82 bends in the extension side gradually increases as the pedal stroke increases. Therefore, the brake pedal device of the second embodiment can also improve the operability by the driver, similar to the first embodiment.

### Third Embodiment

As shown in FIG. 16, in the brake pedal device of the third embodiment, a portion of the shaft member 20 that is on the vehicle front side of the axis CL is located on an extension line EL of the operating portion average surface. In other words, the shape of the tread surface 41 of the pedal operating portion 40 is defined so that a part of the shaft member 20 is positioned on an extension line EL of the operating portion average surface over the entire range of the pedal stroke. The diameter of the shaft member 20 is, for example, about 5 to 10 mm. This configuration also makes it possible to realize a configuration in which the angle at which the driver's MTP joint 82 bends in the extension side gradually increases as the pedal stroke increases. Therefore, the brake pedal device of the third embodiment can also improve the operability by the driver, similar to the first embodiment.

### Fourth Embodiment

As shown in FIG. 17, the pedal operating portion 40 provided in the brake pedal device of the fourth embodiment has a tread surface 41 facing the driver, which is formed in a curved shape that is concave on the front side of the vehicle. In the fourth embodiment as well, a portion of the shaft member 20 is located on the extension line EL of the operating portion average surface. In other words, the curved shape of the tread surface 41 of the pedal operating portion 40 is defined so that a portion of the shaft member 20 is positioned on an extension line EL of the operating portion average surface over the entire range of the pedal stroke. This configuration also makes it possible to realize a configuration in which the angle at which the driver's MTP joint 82 bends in the extension side gradually increases as the pedal stroke increases. Therefore, the brake pedal device of the fourth embodiment can also improve the operability by the driver, similar to the first embodiment.

### Fifth Embodiment

As shown in FIG. 18, the pedal operating portion 40 provided in the brake pedal device of the fifth embodiment has a tread surface 41 facing the driver, which is formed in a curved shape that is convex toward the rear side of the vehicle. In the fifth embodiment as well, a portion of the shaft member 20 is located on the extension line EL of the operating portion average surface over the entire range of the pedal stroke. In other words, the curved shape of the tread surface 41 of the pedal operating portion 40 is defined so that a portion of the shaft member 20 is positioned on an extension line EL of the operating portion average surface over the entire range of the pedal stroke. This configuration also makes it possible to realize a configuration in which the angle at which the driver's MTP joint 82 bends in the extension side gradually increases as the pedal stroke increases. Therefore, the brake pedal device of the fifth embodiment can also improve the operability by the driver, similar to the first embodiment.

### Sixth Embodiment

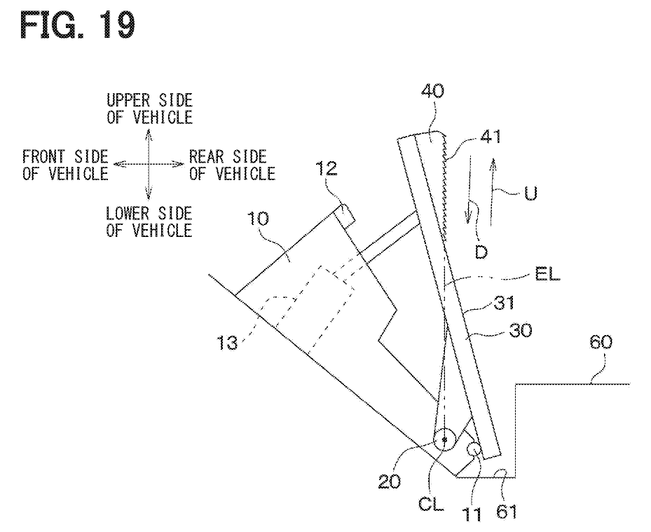

As shown in FIG. 19, the brake pedal device of the sixth embodiment varies the coefficient of friction of the tread surface 41 of the pedal operating portion 40. In other words, this brake pedal device is designed so that the coefficient of friction when an object moves on the tread surface 41 of the pedal operating portion 40 from the upper side of the vehicle to the lower side of the vehicle is different from the coefficient of friction when an object moves on the tread surface 41 from the lower side of the vehicle to the upper side of the vehicle. Specifically, this brake pedal device has a larger coefficient of friction when an object moves on the tread surface 41 of the pedal operating portion 40 from the upper side of the vehicle to the lower side of the vehicle than when the object moves on the tread surface 41 from the lower side of the vehicle to the upper side of the vehicle. The tread surface 41 of the pedal operating portion 40 is made of, for example, a material having a shape similar to that of an inclined pile fabric.

In FIG. 19, an arrow D indicates the direction in which the sole 72 moves on the tread surface 41 of the pedal operating portion 40 when the driver presses the pedal operating portion 40 down, and an arrow U indicates the direction in which the sole 72 moves on the tread surface 41 of the pedal operating portion 40 when the driver releases the pedal operating portion 40. In the sixth embodiment, the coefficient of friction when the sole 72 moves on the tread surface 41 of the pedal operating portion 40 when the driver presses the pedal operating portion 40 down can be made larger than the coefficient of friction when the sole 72 moves on the tread surface 41 of the pedal operating portion 40 when the driver presses the pedal operating portion 40 down. This allows the driver to maintain the pedal stroke at that time even if he or she reduces the pedal force applied to the pedal operating portion 40 during the pedal depression operation or pedal release operation. Therefore, the brake pedal device allows the driver to easily maintain the pedal stroke at any position, improving operability.

### Seventh and Eighth Embodiments

The seventh and eighth embodiments are different from the first embodiment in that the configuration of the floor 60, etc. is changed, but the rest is the same as the first embodiment, etc., so only the parts that are different from the first embodiment, etc. will be described.

### Seventh Embodiment

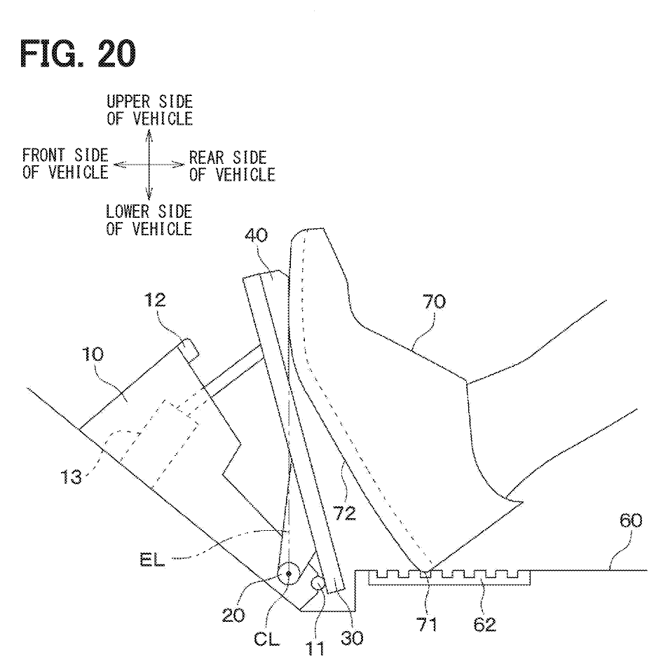

As shown in FIG. 20, the brake pedal device of the seventh embodiment is provided with a heel contact portion 62 at a position on a floor 60 or the like where it comes into contact with a heel 71 of a shoe 70 worn by a driver. The heel contact portion 62 is provided at a position a predetermined distance on the rear side of the vehicle from the shaft member 20, and is a member that can prevent the heel 71 of the shoe 70 from moving forward of the vehicle. The coefficient of friction of the surface of the heel contact portion 62 facing the upper side of the vehicle is set to be greater than the coefficient of friction of the floor 60 and other portions excluding the heel contact portion 62. The heel contact portion 62 may be configured integrally with the floor 60 or the like, or may be configured as a separate member from the floor 60 or the like. The heel contact portion 62 is made of, for example, a high-friction material or has an uneven shape.

In the seventh embodiment described above, when the driver depresses the pedal operating portion 40, the heel contact portion 62 provided on the floor 60 or the like allows the driver to easily fix the position of the heel 71 of the shoe 70. Therefore, the tendency for the angle at which the driver's MTP joint 82 bends toward the extension side to gradually increase as the pedal stroke increases can be enhanced, improving operability for the driver.

### Eighth Embodiment

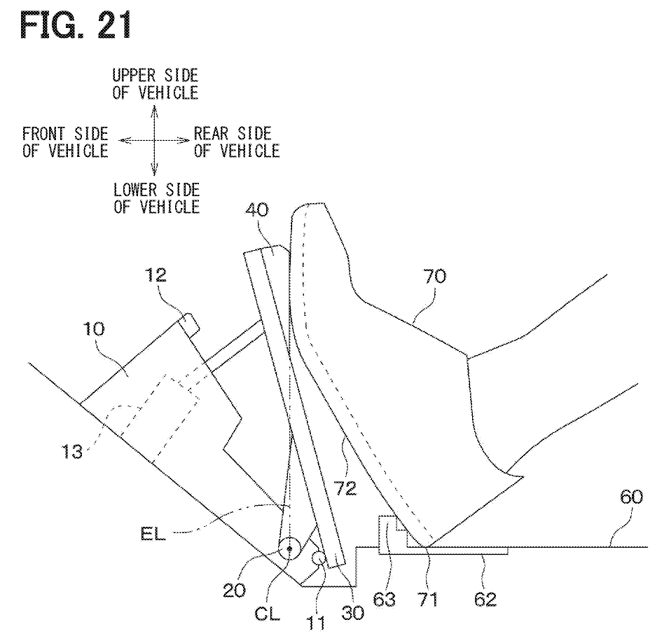

As shown in FIG. 21, the brake pedal device of the eighth embodiment has a protruding portion 63 protruding upward from a part of the heel contact portion 62. The protruding portion 63 is provided at a portion of the heel contact portion 62 that is closer to the front side of the vehicle than the portion that the heel 71 of the driver's shoe 70 contacts. The protruding portion 63 is shaped to protrude on the upper side of the vehicle beyond the portion of the heel contact portion 62 that is to be contacted by the heel 71 of the driver's shoe 70. The protruding portion 63 may be formed in a stepped shape as shown in FIG. 21. The protruding portion 63 is not limited to a stepped shape, but may be, for example, an inclined surface shape.

In the eighth embodiment described above, when the driver depresses the pedal operating portion 40, the position of the heel 71 of the shoe 70 worn by the driver can be easily fixed by the protruding portion 63 provided on the floor 60 or the like. Therefore, the tendency for the angle at which the driver's MTP joint 82 bends toward the extension side to gradually increase as the pedal stroke increases can be enhanced, improving operability for the driver.

### Ninth Embodiment

The ninth embodiment differs from the first embodiment in that the mounting position of the brake pedal device relative to the floor 60, etc., and the sizes of the pedal base 30 and the pedal operating portion 40 are changed, but otherwise the ninth embodiment is the same as the first embodiment, etc. Therefore, the ninth embodiment will be described only with respect to the parts that are different from the first embodiment and the like.

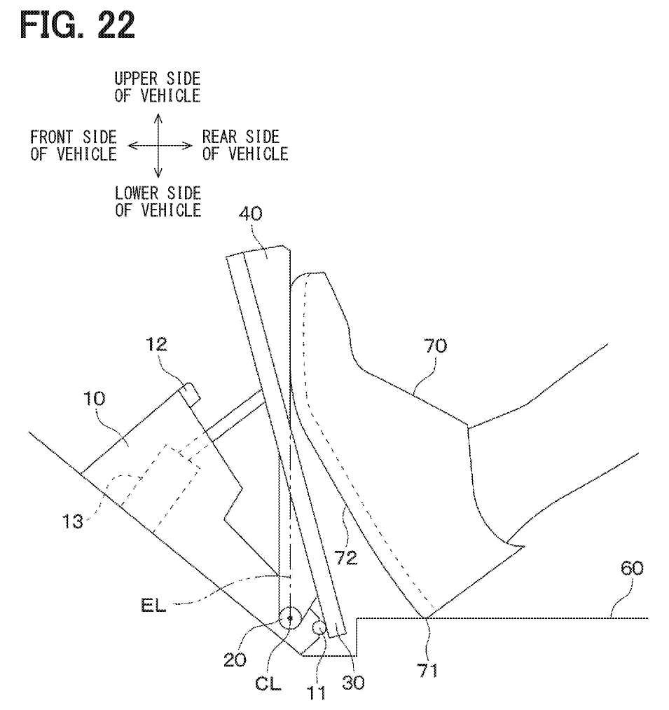

As shown in FIG. 22, the brake pedal device of the ninth embodiment is mounted so that the axis CL of the shaft member 20 and the upper surface of the floor 60 or the like are positioned at the same height in the vehicle vertical direction. In addition, the brake pedal device has the pedal base 30 and the pedal operating portion 40 that are formed to be equal to or larger than the size of a shoe 70 of an average driver. This ninth embodiment can also achieve the same effects as the first embodiment and the like.

### Other Embodiments

(1) In the above embodiments, the brake pedal device is described as being used in a brake-by-wire system, but is not limited to this configuration. The brake pedal device may, for example, not be used in a brake-by-wire system but be mechanically connected to a conventional master cylinder. The brake pedal device may also be used in a brake-by-wire system and be mechanically connected to a master cylinder, for example. In this case, the reaction force generating mechanism 13 may be omitted.

(2) In the above embodiments, the sensor unit 50 included in the brake pedal device is described as being provided on the axis CL of the shaft member 20, but another configuration may be adopted. The sensor unit 50 may be provided, for example, at a position away from the axis CL of the shaft member 20. The sensor unit 50 may also detect the angle, position, stroke, etc. of the shaft member 20, the pedal base 30, the pedal operating portion 40, or a member that moves in synchronization with these components.

(3) In the above embodiments, the sensor unit 50 provided in the brake pedal device is described as being composed of a magnetic circuit, a Hall IC 55, and the like, but is not limited to this configuration. The sensor unit 50 may be configured, for example, by a magnetoresistive element, an inductive sensor, or the like.

(4) In each of the above embodiments, the brake pedal device is configured such that the shaft member 20 is rotatable relative to the support portion 10. However, the present disclosure is not limited to this configuration. The brake pedal device may be configured, for example, such that the support portion 10 and the shaft member 20 are fixed, and the pedal base 30 is rotatably provided relative to the shaft member 20.

(5) In each of the above embodiments, the support portion 10 of the brake pedal device is described as a housing having an internal space therein. However, the present disclosure is not limited to this configuration and may be configured in any way as long as it is capable of supporting the shaft member 20.

The present disclosure is not limited to the above-described embodiments, and can be appropriately modified. The above-described embodiments and a part thereof are not irrelevant to each other, and can be appropriately combined with each other unless the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle. A quantity, a value, an amount, a range, or the like referred to in the description of the embodiments described above is not necessarily limited to such a specific value, amount, range or the like unless it is specifically described as essential or understood as being essential in principle. Further, in each of the above-mentioned embodiments, when referring to the shape, positional relationship, and the like of a component and the like, the component is not limited to the shape, positional relationship, and the like, except for the case where the component is specifically specified, the case where the component is fundamentally limited to a specific shape, positional relationship, and the like.

What is claimed is:

1. A brake pedal device mounted on a vehicle, comprising:
a support portion attached to the vehicle;
a shaft member provided on the support portion;
a pedal base provided rotatably around an axis of the shaft member within a predetermined angle range relative to the support portion; and
a pedal operating portion configured to be provided at the pedal base and be stepped on by a driver, wherein
the axis is located on an opposite side of the pedal base from a surface of the pedal base that faces the driver with respect to a center line in a thickness direction of the pedal base, and
when the driver wears a shoe and depresses the pedal operating portion, a positional relationship between the shaft member and the pedal operating portion is defined so that a heel of the shoe is brought into contact with a position on a floor of the vehicle or a member placed on the floor that is a predetermined distance on the rear side of the vehicle from the axis, and the driver steps on the pedal operating portion with both a ball and a pad of the big toe in contact with an insole of the shoe, and the angle at which a driver's MTP joint bends toward an extension side increases as a pedal stroke increases.

2. The brake pedal device according to claim 1, further comprising,
a sensor unit provided on the axis and configured to detect a rotation angle of the shaft member, the pedal base, and the pedal operating portion relative to the support portion.

3. The brake pedal device according to claim 1, wherein
the brake pedal device is an organ structure type in which the pedal operating portion is disposed on an upper side of the vehicle with respect to the axis, and
an angle formed between an operating portion average surface, which is an average of an entire tread surface of the pedal operating portion facing the driver side, and a base average surface, which is an average of the entire surface of the pedal base, which faces the driver side, is smaller than 180° on a driver side.

4. The brake pedal device according to claim 1, wherein
the shaft member is positioned on an extension line of the operating portion average surface of the pedal operating portion, which is an average of an entire tread surface of the pedal operating portion facing the driver, throughout an entire range of the pedal stroke.

5. The brake pedal device according to claim 1, wherein
the axis is positioned on a lower side in a vehicle vertical direction than the floor or a member placed on the floor, or is at the same height in the vehicle vertical direction as the floor or a member placed on the floor.

6. The brake pedal device according to claim 1, wherein
a coefficient of friction when an object moves from an upper side of the vehicle to a lower side of the vehicle on a tread surface of the pedal operating portion facing the driver is different from the coefficient of friction when the object moves from the lower side of the vehicle to the upper side of the vehicle on the tread surface.

7. The brake pedal device according to claim 1, wherein
a coefficient of friction when an object moves from a lower side of the vehicle to an upper side of the vehicle on a tread surface of the pedal operating portion facing the driver is greater than the coefficient of friction when the object moves from the upper side of the vehicle to the lower side of the vehicle on the tread surface.

8. The brake pedal device according to claim 1, further comprising,
a heel contact portion that is capable of abutting against the heel of the shoe worn by the driver and restricting movement of the heel toward the front side of the vehicle, the heel contact portion being provided at a position on the floor or on a member placed on the floor that is a predetermined distance on the rear side from the shaft member.

9. The brake pedal device according to claim 8, wherein
the friction coefficient of the surface of the heel contact portion facing the upper side of the vehicle is greater than the friction coefficient of the floor or a portion of a member placed on the floor excluding the heel contact portion.

10. The brake pedal device according to claim 8, wherein
the heel contact portion has a protruding portion that protrudes on the upper side of the vehicle at a position forward of the vehicle from the point where the heel of the shoe worn by the driver contacts.

11. A brake pedal device mounted on a vehicle, comprising:
a support portion attached to the vehicle;
a shaft member provided on the support portion;
a pedal base provided rotatably around an axis of the shaft member within a predetermined angle range relative to the support portion; and
a pedal operating portion configured to be provided at the pedal base and be stepped on by a driver, wherein
the axis is located on an opposite side of the pedal base from a surface of the pedal base that faces the driver with respect to a center line in a thickness direction of the pedal base, and
when the pedal operating portion is depressed using a human body model, a positional relationship between the shaft member and the pedal operating portion is specified so that a heel of the human body model is brought into contact with a floor of the vehicle or a member placed on the floor at a position a predetermined distance on the rear side of the vehicle from the axis, and the pedal operating portion is depressed with both a ball and a pad of the big toe of the human body model in contact with the pedal operating portion, and an angle at which a MTP joint of the human body model bends toward an extension side increases as a pedal stroke increases.

12. A brake pedal device mounted on a vehicle, comprising:
a support portion attached to the vehicle;
a shaft member provided on the support portion;
a pedal base provided rotatably around an axis of the shaft member within a predetermined angle range relative to the support portion; and
a pedal operating portion configured to be provided at the pedal base and be stepped on by a driver, wherein
the axis is located on an opposite side of the pedal base from a surface of the pedal base that faces the driver with respect to a center line in a thickness direction of the pedal base, and
the shaft member is positioned on an extension line of an operating portion average surface of the pedal operating portion, which is an average of an entire tread surface of the pedal operating portion facing the driver, throughout an entire range of the pedal stroke.
